(19) United States
(12) Patent Application Publication
(10) Pub. No.: US 2005/0144143 A1
(43) Pub. Date: Jun. 30, 2005

(54) Method and system for identity theft prevention, detection and victim assistance

(76) Inventor: Steven Freiberg, Jericho, NY (US)

Correspondence Address: KILPATRICK STOCKTON LLP, 607 14TH STREET, N.W., WASHINGTON, DC, 20005, US

(21) Appl. No.: 10/933,261

(22) Filed: Sep. 3, 2004

Related U.S. Application Data
(60) Provisional application No. 60/499,378, filed on Sep. 3, 2003.

(51) Int. Cl. G06F 17/60

(52) U.S. Cl. 705/75

(57) ABSTRACT

A method and system for providing comprehensive assistance to victims dealing with the aftermath of identity theft fraud. An identity theft prevention/detection service is combined with a comprehensive victim assistance program wherein victims of identity theft not only have the capability of restoring their good name and credit worthiness on an individual tradeline basis, but also on the basis of all their creditor relationships.

### PRIORITY

This application claims priority to U.S. Provisional Patent Application Ser. No. 60/499,378, filed on Sep. 3, 2003, the entire disclosure of which is incorporated herein by reference.

### FIELD OF THE INVENTION

The present invention relates generally to a method and system for providing comprehensive assistance to victims dealing with the aftermath of identity theft. More particularly, but not by way of limitation, the present invention is a method and system for a hybrid approach that offers an identity theft prevention/detection service combined with a comprehensive victim assistance program.

### BACKGROUND OF THE INVENTION

Identity theft is the unauthorized use of personal information such as name, address, social security number, date of birth and mother's maiden name to establish or assume credit under someone else's name. Identity theft manifests itself primarily in two ways: First, as a fraudulent application in which a new credit relationship is established using someone else's personal information, and, second, through account takeover in which an existing credit relationship is assumed using someone else's personal information.

Identity theft occurs through various means, for example, through increased availability of information online and elsewhere (MMN, passwords, etc.); illegal access to credit bureau information; illegal sale of information by trusted sources (governmental agencies, collusive employees, etc.); fraud scams that seek this information directly from consumers; acquaintance/family member who generally has access to a victim's personal information; and theft of information from an unlocked mailbox, stolen purse/wallet or discarded information in the garbage.

Current processes that exist to assist victims of identity theft are primarily based on an institution's (e.g., a bank's) individual creditor relationship with the victim. Therefore, there are several different systems (even within an institution, such as between a bank's card business and banking business) whereby the victim has to work with different units in order to have his or her identity restored. For example, the victim would contact a particular unit of a bank to close a particular account. The victim is then transferred to another unit for another account, and even to a further unit that would provide victim assistance.

Accordingly, there is a need for a victim assistance method and system that provides victims of identity theft not only the capability of restoring their good name and credit worthiness on an individual tradeline basis, but also on the basis of all their creditor relationships.

### BRIEF DESCRIPTION OF THE DRAWINGS

In the drawings:

FIG. 1 illustrates a theft prevention process flow of an embodiment of the present invention; and

FIG. 2 illustrates a victim assistance process flow of an embodiment of the present invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

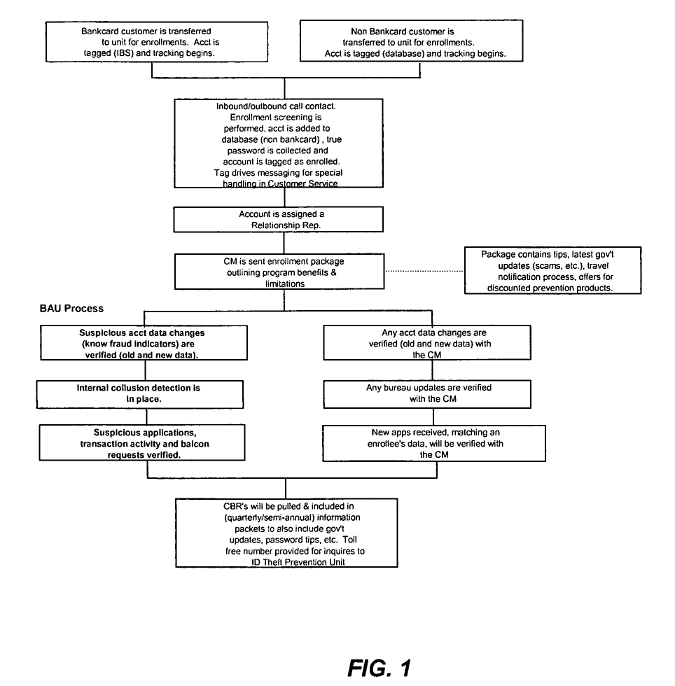

An embodiment of the present invention relates to identity theft prevention. See FIG. 1. A further embodiment relates more particularly to prevention actions involving a free service product. This embodiment verifies suspicious account data changes that match a fraud indicator system, such as the Known Fraud Indicator System (KFIS), and industry data, such as, Issuer Clearing Service (ICS) alerts. The embodiment further comprises monitoring for internal collusion to identify potential compromise issues, and monitoring suspicious applications, transaction activity, and high risk requests. The embodiment further verifies activity with the customer to ensure it was authorized.

Another embodiment of the present invention relates to prevention actions involving a fee-based product. This embodiment includes a methodology for sending credit bureau reports to the customer on, for example, a quarterly or semiannual basis, and to assist him or her in reviewing for potentially unauthorized tradelines, not limited to a particular institution. The methodology includes working with the customer to establish a true password on all accounts and recommending that the customer update all creditor relationships with a password. Further, in this embodiment, at the time of account data changes (e.g., address), the changes are verified with the customer to ensure they were authorized. In another embodiment, the present invention ensures that any new applications received, which have information matching an enrollee's data, are verified with the customer. In a further embodiment, discounts are offered on preventative merchandise that may assist in protecting the customer (e.g., shredders, locking mailboxes, etc.).

In another embodiment of the present invention, bank card detection actions are provided against fraudulent applications. For example, postcards are sent to verify suspicious applications; authorization detection strategies are used to detect out-of-pattern spending and payments, and the potential victim is proactively contacted to validate transactions; the KFIS database records all fraudulent addresses and the phone numbers listed on accounts; manual reports look for new accounts with a balance transfer check request; investigations are conducted on accounts that have credit inquiries by collusive credit bureau subscribers; police reports are filed when identity theft perpetrators are identified; and investigative intelligence is shared in a working relationship with law enforcement to prosecute criminals.

In a further embodiment of the present invention, bank card detection actions are provided against Account Take Over (ATO). For example, an embodiment performs incremental verification when high risk requests are made on an account; authorization detection strategies monitor for high risk ATO transactions; and the KFIS database records all fraudulent addresses and phone numbers that are listed on accounts identified as an ATO. This database then monitors the host system for any other accounts that are changed to that address.

A further embodiment of the present invention includes high risk transactions reports (e.g., involving address change and card request sent to a high risk zip code area or an overnight card request to alternate shipping address located in a high risk zip code area). Additionally, customers who are victimized by ATO fraud have their account flagged to ensure that a representative handling the customers' next inquiry is aware that the customers have been impacted by ATO fraud. Embodiments also include internal collusion detection controls managed, e.g., through an Internal Investigation/Fraud Policy unit.

Embodiments of the present invention also include identity theft controls such as supporting the prioritization of passwords, IP address capture, enhanced fraud variable TPR, and CBR fraud alerts. Further embodiments include, for example, private label detection actions pertaining to high risk client checks whereby store applications are reviewed that have a higher fraud rate based on historical details. Other embodiments include FEW suspicious activity monitoring such as the billing address/ship-to-address mismatch.

Additional embodiments of the present invention also relate to the following: Fraud scoring whereby a systemic score attempts to predict the likelihood of fraud on an application; New Account Processing System (NAPS) fraud controls wherein NAPS verification of information is provided by the customer; California identity theft legislation that targets applications from California where the bureau details differ from the application details; a database that looks for bureau variations, such as a suspect database; and fraud victim statements whereby calls are made to the phone number provided to verify the applicant applied for the account.

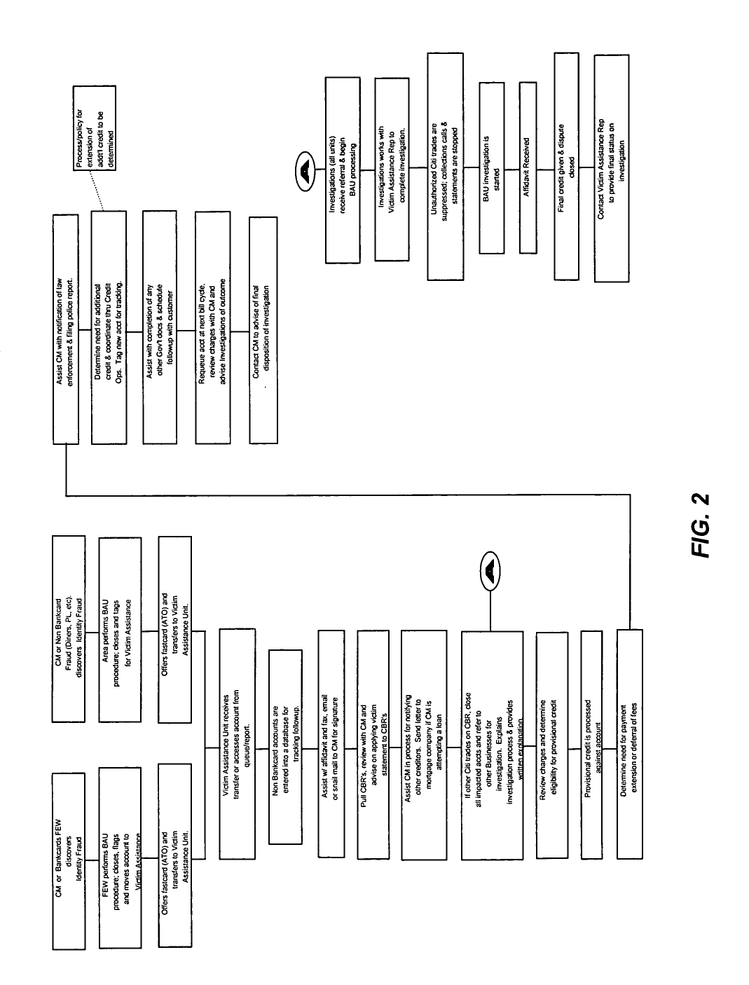

Embodiments of the present invention also include victim assistance actions. See FIG. 2. For unauthorized tradelines, for example, the trade is deleted from the bureau and reporting is suppressed. Collection calls are stopped immediately and statements are no longer sent on the account. Victims are referred to the credit bureaus to apply a victim statement to each of the bureaus, and card member disputes are investigated as individual businesses. Further, victims are referred to other creditors to close their account. Embodiments of the invention also include instructing the victim to file a police report with local law enforcement, providing identity theft brochures to the customer if requested, and sending a letter to a mortgage company if the customer is attempting to get a loan.

Embodiments of the present invention also comprise the following: Upon notification from the customer, pulling the bureau reports and reviewing the trades with the customer to determine if any are unauthorized; contacting the bureau with the customer on the line to assist him in applying a victim statement; completing all paper work required to substantiate the victim statement; and sending the information to the customer who will then sign the notification and send it to the bureaus.

Embodiments of the present invention further include acting for the customer and/or providing assistance to the customer to make it easier for him or her to recover from an identity theft incident. In a further embodiment of the present invention, as a first step, a new account is established and the victim gets his new card in hand, for example, within 24 hours as a fast card and a case is created for tracking and follow-up. Information is taken from the customer that assists in completing a universal affidavit form for the customer, indicating that he is a victim of identity fraud. The customer is assisted in completing the affidavit. The affidavit is sent to the customer either, for example, via fax, e-mail, or worse case, through regular mail so that the customer can sign the affidavit and then forward it to a creditor.

The credit bureau report is pulled with the customer online so that the inquiries and the tradelines on those bureaus can be reviewed with the customer in order to determine which items were unauthorized or had been compromised. The credit bureaus are then contacted in order to place the victim's statement on those bureaus and indicate what items are in dispute. Working with the customer, creditors are contacted in order to close the affected accounts or correct the disputed items. Additionally, correspondence is issued to creditors to indicate that the customer has initiated an identity theft claim.

In a further embodiment of the present invention, if the customer indicated a need for additional credit, a review, for example, for a credit line increase is performed if there is a valid account open or, upon a customer's request, an account is established through which credit could be provided. In one embodiment a follow-up is scheduled, for example, within 30 days to re-contact the customer to review yet again the bureau reports for any new inquiries or tradelines that have come up that are either unauthorized or compromised. Activity will continue to be monitored on a case-by-case basis. For example, monitoring could last for 90 days to six months until the case is brought to a full resolution

Further embodiments of the present invention include providing information which will allow the customer to contact all unauthorized creditors and request that the affected accounts be closed. If approved by the creditor, a universal affidavit, as noted above, is completed and sent to the customer for signature. The customer then sends it to a representative who will forward it to all investigative units. Thereafter, the customer sends the affidavit to other creditors as required.

Other embodiments of the present invention comprise meeting with a field investigations staff to outline the typical questions used on police reports and to document these items for the customer. The questions are completed and this information is sent to the customer. The customer then takes this information to his or her local law enforcement authority. Further embodiments include filling out the appropriate governmental agency (e.g., Federal Trade Commission, Social Security Administration, etc) documentation and forwarding it to the customer for review and submission.

In account takeover and limited fraud application incidents, embodiments of the present invention include working with the customer to determine if an extension of credit to cover necessary transaction activity during the investigation can be facilitated. Additionally, potential credit extension opportunities for identity theft victims are outlined with the credit policy unit.

If the customer is applying for a mortgage, embodiments of the invention provide for a letter to be written to the lender educating the lender that identity theft has been reported and creditors are currently investigating claims. Individual business dispute representatives proactively contact the victim to explain the actions that will be taken on the accounts. A written explanation of the actions that will be taken to assist the victim is also provided. Unauthorized tradelines continue to be deleted from the bureau report, bureau reporting is suppressed, and collection calls and statements are stopped. At the time of the next billing cycle, the account is re-queued and the customer is contacted to review the transaction activity. At the time the investigations are complete, final resolution of the investigation is communicated to the customer. Because identity theft incidents are often committed by family members and acquaintances, the customer is assisted regardless of how the identity theft may have occurred.

Further embodiments of the present invention comprise establishing a specialized unit to receive calls servicing an identity theft program. The unit has access to all card platforms. Certain accounts are assigned to a specialized unit in which a specific person is appointed to work with the victim. This allows a relationship to be established between the victim and the servicing representative, while providing stability during a traumatic event. Additionally, this minimizes the need for the customer to repeatedly explain his or her situation. Embodiments of the present invention also includes, at the time of initial enrollment, providing the customer with an identity theft welcome kit that focuses on how to prevent identity theft. This includes an internet link and a checklist of actions that should be taken to minimize the potential of identity theft. Phone numbers to call in the event of suspected identity theft is also included.

Embodiments of the present invention have now been described in fulfillment of the above objects. It will be appreciated that these examples are merely illustrative of the invention. Many variations and modifications will be apparent those skilled in the art.

1. A method comprising:
electronically monitoring at least one account associated with a customer for potential fraudulent activity;
identifying potential fraudulent activity based on one or more fraud indicators;
verifying the fraudulent activity with the customer;
automatically storing information relating to the account and fraudulent activity in a database;
assisting the customer to rectify the fraudulent activity.
